(19) United States
(12) Patent Application Publication
(10) Pub. No.: US 2021/0311901 A1
(43) Pub. Date: Oct. 7, 2021

(54) DATA AND POWER SUPPLY PORTS IN GUIDERAILS

(71) Applicant: Hewlett-Packard Development Company, L.P., Spring, TX (US)

(72) Inventors: Binh T. Truong, Spring, TX (US); Chi So, Spring, TX (US); Nam H. Nguyen, Spring, TX (US)

(73) Assignee: Hewlett-Packard Development Company, L.P., Spring, TX (US)

(21) Appl. No.: 17/274,544

(22) PCT Filed: Nov. 28, 2018
(86) PCT No.: PCT/US2018/062739

§ 371 Date: Mar. 9, 2021

(51) Int. Cl. G06F 13/40; G06F 1/26; G06F 13/42

(52) U.S. Cl. CPC G06F 13/4068; G06F 2213/0042; G06F 13/4282; G06F 1/266

(57) ABSTRACT

A display device may include a universal serial bus (USB) hub formed within a housing of the display device; a plurality of USB ports, each of a plurality of USB ports communicatively coupled to the USB hub via a ribbon; a guiderail formed on an outer surface of the housing display with each of the plurality of USB ports coupled thereto to allow the movement of the USB ports along the guiderail.

### BACKGROUND

Computing devices may interface with a number of peripheral devices. The peripheral devices may add further functionality to the computing device. Some of these peripheral devices may include cameras, speakers, card readers, and web cams, among others. Each of these peripheral devices may add corresponding functionalities to the computing device thereby increasing the functionality of the computing device itself.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a display device according to an example of the principles described herein.

FIG. 2 is a block diagram of a computing device according to an example of the principles described herein.

FIG. 3 is a block diagram of a universal serial bus (USB) system according to an example of the principles described herein.

FIG. 4 is a side cut-out view of a portion of a display device having a guardrail according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A computing device may include any number of peripheral devices that increase its functionality. A user may communicatively couple the peripheral device to the computing device using any wired or wireless connection. Although the peripheral devices may be communicatively coupled to the computing device allowing for a variety of functionality and customization of the computing device, the placement of these peripheral devices may be limited. This may occur where the peripheral devices are meant to be coupled to a display device or screen of the computing device.

The present specification describes a display device that includes universal serial bus (USB) hub formed within a housing of the display device; a plurality of USB ports, each of a plurality of USB ports communicatively coupled to the USB hub via a ribbon; a guiderail formed on an outer surface of the housing display with each of the plurality of USB ports coupled thereto to allow the movement of the USB ports along the guiderail.

The present specification further described a computing device that includes a processor and a display device, the display device including: a data and power supply hub formed within a housing of the display device; a plurality of data and power supply ports, each of a plurality of data and power supply ports communicatively coupled to the data and power supply hub via a ribbon; a guiderail formed on an outer surface of the housing display with each of the plurality of data and power supply ports coupled thereto to allow the movement of the data and power supply ports along the guiderail.

The present specification further describes a universal serial bus (USB) system, including a USB port communicatively coupled to a USB hub via a ribbon and a guiderail formed on an outer surface of a housing of a display device wherein the USB port is coupled to the guiderail to allow the movement of the USB port along the guiderail.

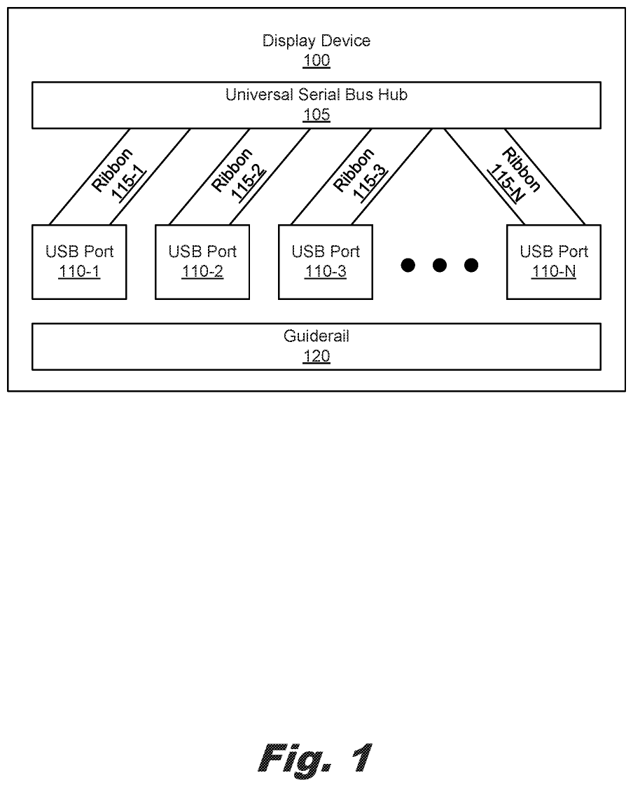

Turning now to the figures, FIG. 1 is a block diagram of a display device (100) according to an example of the principles described herein. The display device (100) may be any type of display device (100) that may present to a user an image to a user. Example of display devices (100) may include a television, an external monitor external to a computing device, a computer screen, and a laptop screen, among others. Although specific examples of a display device (100) may be described herein, the present specification contemplates that the display device (100) may be any device that can present to user the images described herein.

The display device (100) includes a universal serial bus (USB) hub (105). In any example presented herein, the USB hub (100) may be used to expand any USB port into a plurality of USB ports as described herein. In the examples presented herein, the USB hub (100) may be communicatively and electrically coupled to a plurality of universal serial bus (USB) ports (110-1, 110-2, 110-3, 110-N) via a plurality of ribbons (115-1, 115-2, 115-3, 115-N). The USB hub (100) may receive and send any data and any level of power to any one of the individual USB ports (110-1, 110-2, 110-3, 110-N).

In an example, the USB hub (100), ribbons (115-1, 115-2, 115-3, 115-N), and/or portions of the USB ports (110-1, 110-2, 110-3, 110-N) may be formed within a housing of the display device (100). Housing of the display device (100) may further fit a screen therein with the USB hub (100), ribbons (115-1, 115-2, 115-3, 115-N), and USB ports (110-1, 110-2, 110-3, 110-N) behind the screen.

In an example, the housing of the display device (100) may include a guiderail (120). The guiderail (120) may be formed on any portion of the housing of the display device (100). In a specific example, the guiderail (120) may be formed on a surface of the housing of the display device (100) that surrounds the screen of the display device (100). This surface may be orthogonal to the surface of the screen of the display device (100). To facilitate the coupling of a peripheral device to the display device (100), each of the USB ports (110-1, 110-2, 110-3, 110-N) may be mechanically coupled to the guiderail (120) formed on the surface of the display device (100). Thus, each of the USB ports (110-1, 110-2, 110-3, 110-N) may be accessible to a user along an outer surface of the display device (100). Additionally, because each of the USB ports (110-1, 110-2, 110-3, 110-N) are mechanically coupled to the guiderail (120), the guiderail (120) may be used to adjust the position along the outer surface of the display device (100) so that the location of the USB ports (110-1, 110-2, 110-3, 110-N) may be adjustable by a user. By being allowed to adjust the position of each of the USB ports (110-1, 110-2, 110-3, 110-N), a user may, in turn, adjust any peripheral device communicatively and electrically coupled to the USB hub (100) via the ribbons (115-1, 115-2, 115-3, 115-N) and individual USB ports (110-1, 110-2, 110-3, 110-N).

In an example, the USB ports (110-1, 110-2, 110-3, 110-N) may be movable after a peripheral device has been coupled thereto. In this example, the interface of the peripheral device to the USB port (110-1, 110-2, 110-3, 110-N) may be used to move the USB port (110-1, 110-2, 110-3, 110-N) to any position along the before-mentioned surface of the display device (100). This allows the user to customize the position of any peripheral device coupled to the display device (100). This may be done so as to, in the case of a camera for example, allow a user to adjust the position of the camera in order to be directed to the user regardless of the user's position relative to the display device (100) and/or the user's height. Similar adjustments to other types of peripheral devices may be made using the USB ports (110-1, 110-2, 110-3, 110-N) coupled to the guiderail (120) thereby increasing the customization and usability of any display device (100) described herein. In an example, the peripheral device may include a card reader. The card reader may be associated with a teller system in a point-of-sale scenario such that a user may swipe a card at any position along the display device (210).

The USB ports (110-1, 110-2, 110-3, 110-N) themselves may be any type of USB port including type A USB port; type B USB port; mini A USB port; mini B USB port; mini AB USB port; micro A USB port; micro B USB port; micro AB USB port; and type C USB port. In an example, any of these types of USB ports may be used and coupled to the guiderail (120). In this example, the display device (100), with the varying types of USB ports, may provide coupling of any type of peripheral device regardless of the corresponding type of USB connection associated with those peripheral devices. Each of the USB ports (110-1, 110-2, 110-3, 110-N) may include a low power switch. The low power switch may be used by the display device (100) and the USB hub (100) therein to detect when a peripheral device is coupled to any of the USB ports (110-1, 110-2, 110-3, 110-N). This allows the USB hub (100) to provide power to the peripheral when connected as well as particularly set the appropriate power to the attached peripheral device.

In an example, the USB ports (110-1, 110-2, 110-3, 110-N) may include a locking mechanism. The locking mechanism may secure any of the USB ports (110-1, 110-2, 110-3, 110-N) at any location along the guiderail (120). The locking mechanism may be any type of locking mechanism including screws, quick locks, and the like.

In an example, the display device (100) may include a rubber seal. the rubber seal may cover some or all of the guiderail (120) and USB ports (110-1, 110-2, 110-3, 110-N) so as to prevent contaminants such as dirt and dust from entering the guiderail (120) and or individual USB ports (110-1, 110-2, 110-3, 110-N). In any example, the rubber seal may be separated apart so that the user may introduce a peripheral device to any of the plurality of USB ports (110-1, 110-2, 110-3, 110-N). When the peripheral device is separated from any of the USB ports (110-1, 110-2, 110-3, 110-N), the rubber seal may automatically close to prevent the contaminants from entering the guiderail (120) and USB ports (110-1, 110-2, 110-3, 110-N) so that contaminants don't enter the display device (100).

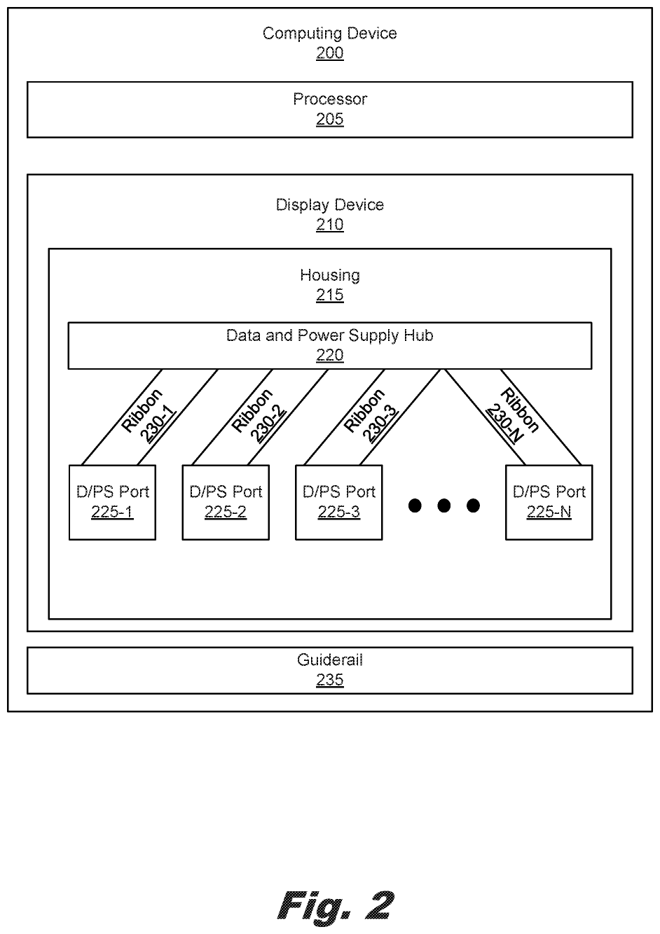

FIG. 2 is a block diagram of a computing device (200) according to an example of the principles described herein. As described herein, a display device (210) may form part of a computing device (200). The computing device (200) may be any type of computing device. Examples of computing devices include servers, desktop computers, laptop computers, personal digital assistants (PDAs), mobile devices, smartphones, gaming systems, and tablets, among other computing devices.

The computing device (200) may be utilized in any data processing scenario including, stand-alone hardware, mobile applications, through a computing network, or combinations thereof. Further, the computing device (200) may be used in a computing network, a public cloud network, a private cloud network, a hybrid cloud network, other forms of networks, or combinations thereof.

To achieve its desired functionality, the computing device (200) may include various hardware components. Among these hardware components may be a number of processors (205), a number of data storage devices, a number of peripheral device adapters as described herein, and a number of network adapters. These hardware components may be interconnected through the use of a number of busses and/or network connections. In one example, the processor (205), data storage device, peripheral device adapters, and network adapter may be communicatively coupled via a bus formed within the computing device (200).

The processor (205) may include the hardware architecture to retrieve executable code from the data storage device (102) and execute the executable code. The executable code may, when executed by the processor (205), cause the processor (205) to implement at least the functionality of the display devices (100, 210), according to the methods of the present specification described herein. In the course of executing code, the processor (205) may receive input from and provide output to a number of the remaining hardware units.

The data storage device may store data such as executable program code that is executed by the processor (205) or other processing device. As will be discussed, the data storage device may specifically store computer code representing a number of applications that the processor (205) executes to implement at least the functionality described herein.

The data storage device may include various types of memory modules, including volatile and nonvolatile memory. For example, the data storage device of the present example includes Random Access Memory (RAM), Read Only Memory (ROM), and Hard Disk Drive (HDD) memory. Many other types of memory may also be utilized, and the present specification contemplates the use of many varying type(s) of memory in the data storage device as may suit a particular application of the principles described herein. In certain examples, different types of memory in the data storage device may be used for different data storage needs. For example, in certain examples the processor (205) may boot from Read Only Memory (ROM), maintain nonvolatile storage in the Hard Disk Drive (HDD) memory, and execute program code stored in Random Access Memory (RAM). The data storage device may comprise a computer readable medium, a computer readable storage medium, or a non-transitory computer readable medium, among others. For example, the data storage device may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The hardware adapters in the computing device (200) enable the processor (205) to interface with various other hardware elements, external and internal to the computing device (200). For example, the peripheral device adapters may provide an interface to input/output devices, such as, for example, display device (210), a mouse, or a keyboard. The peripheral device adapters may also provide access to other external devices such as an external storage device, a number of network devices such as, for example, servers, switches, and routers, client devices, other types of computing devices, and combinations thereof. The peripheral device adapters may also create an interface between the processor (205) and the display device (210), a printer, or other media output devices. The network adapter may provide an interface to other computing devices within, for example, a network, thereby enabling the transmission of data between the computing device (200) and other devices located within the network.

The display device (210) may include a universal serial bus (USB) hub (220). As described herein, the data and power supply hub (220) may interface the processor (205) with any number of data and power supply (D/PS) ports (225-1, 225-2, 225-3, 225-N). The interface may be facilitated by the data and power supply hub (220) communicatively coupled to each of the data and power supply ports (225-1, 225-2, 225-3, 225-N) via a ribbon (230-1, 230-2, 230-3, 230-N). In any example presented herein, the ribbons (230-1, 230-2, 230-3, 230-N) coupling the data and power supply hub (220) to each of the individual data and power supply ports (225-1, 225-2, 225-3, 225-N) may be of any length so that each of the data and power supply ports (225-1, 225-2, 225-3, 225-N) may be passed along any length of the guiderail (235) formed on the housing (215) of the display device (210).

The data and power supply ports (225-1, 225-2, 225-3, 225-N) may be any type of port that provides, to a peripheral device, both data and power supply. In the examples presented herein, a universal serial (USB) port has been used merely as an example. However, other types of data and power supply interfaces may also be contemplated in the present specification and may include, for example, digital visual interfaces, display ports, eSATA ports, PS/2 ports, serial ports, VGA ports, PUSB ports, HDMI, SCSI ports and/or any customized data I/O ports. Each of these additional types of ports include specific data and power supply connectors therein and may include any arrangement of pins/connectors. In the present examples, the data and power supply hub (220) may also be arranged to receive multiple inputs form these myriad types of ports and the present specification contemplates such a hub (220).

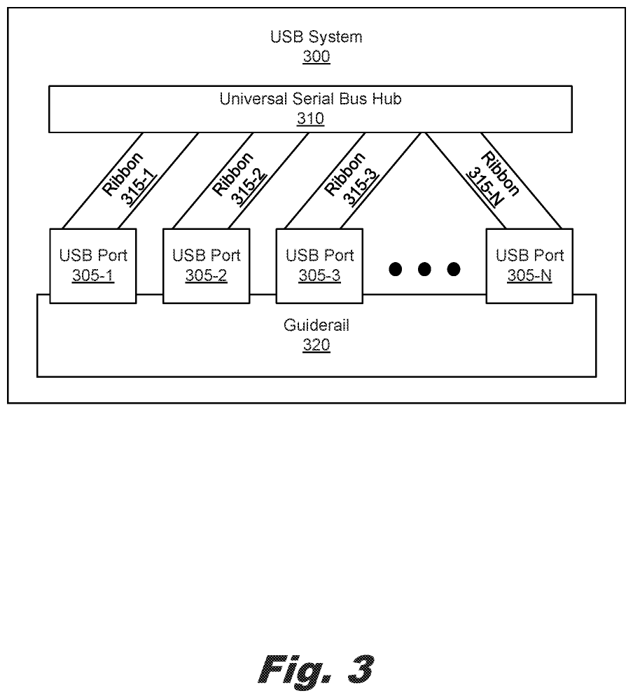

FIG. 3 is a block diagram of a universal serial bus (USB) system (300) according to an example of the principles described herein. As described herein, the universal serial bus (USB) system (300) may include any number of USB ports (305-1, 305-2, 305-3, 305-N) communicatively coupled to a USB hub (310) via any number of ribbons (315-1, 315-2, 315-3, 315-N). The USB ports (305-1, 305-2, 305-3, 305-N) in this and other examples may be mechanically coupled to a guiderail (320) so that the USB ports (305-1, 305-2, 305-3, 305-N) may be moved along a length of the guiderail (320) as described herein. This universal serial bus (USB) system (300) may be implemented within any display device. Additionally, the universal serial bus (USB) system (300) may be communicatively coupled to a processor of a computing device so that a user may interact with the computing device using any peripheral device attached to any of the USB ports (305-1, 305-2, 305-3, 305-N). Thus, the customization on both the type of USB pluggable peripheral device and the placement of those peripheral devices may increase the functionality of the universal serial bus (USB) system (300), computing system, and/or display devices described herein.

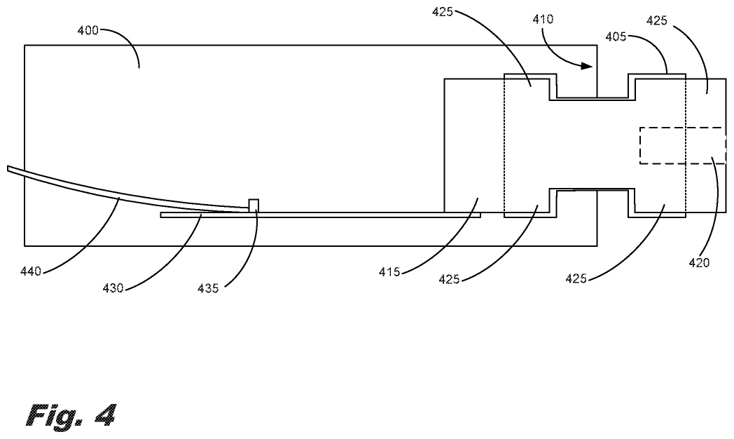

FIG. 4 is a side cut-out view of a portion of a display device (400) having a guardrail (405) according to an example of the principles described herein. As described herein, the display device (400) may include, on a surface (410), a guardrail (405) to allow the selective movement of a number of USB ports (415) along the guardrail (405). The USB ports (415) may include a receptor (420) to receive a USB plug from a peripheral device as described herein. Due to the shape of the guardrail (405), the USB ports (415) may have a slightly smaller profile than the guardrail (405) so as to allow for the USB ports (415) to slip therethrough. Additionally, the USB ports (415) may be locked into the guardrail (405) by including a number of extended portions (425) that prevent the USB ports (415) from slipping out of a track formed by the guardrail (405).

In order to provide for electrical commination and power to the USB ports (415), the USB ports (415) may be coupled to a printed circuit board (PCB) (430). The PCB (430) may include any circuitry used to interface the USB ports (415) to, in an example, a USB hub as described herein. In a specific example, the PCB (430) may include a ribbon connector (435) to receive an end of a ribbon (440). It is this ribbon (440) that electrically and communicatively couples the USB ports (415) to the USB hub and, eventually a processor of a computing. This allows the peripheral device to be electrically coupled to a processor of a computing device so that input and output signals to and from the peripheral device can be sent.

As described herein, the ribbon (440) may include additional circuitry that allows for the detection of the coupled peripheral device and adjust, when applicable, power provided to the peripheral device. Circuitry may include to allow for signals to be sent to and from the peripheral device to the ribbon connector (435). The ribbon (440) provides for relatively better flexibility than a PCB (430) thereby allowing for the movement of the USB ports (415) along the guiderail (320).

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, the processor (205) of the computing device (200) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a display device of, for example, a computing device that includes a universal serial bus system. The USB system includes any number of USB ports that are formed along a guiderail formed on a surface of the display device. Each USB port is coupled to a USB hub via a ribbon cable so that each USB port may be moved along the guiderail. Movement of the USB ports along the guiderail allows for the USB ports to be moved along the guiderail so as to customize the location of any number of peripheral devices when coupled to the USB ports. This adds further flexibility in the customization of peripheral device placement relative to the display device. This allows any user of the display device having any physical characteristics to adjust the described peripherals to fit the user's comfort.

The preceding description has been presented to illustrate and describe examples of the principles described. This description is not intended to be exhaustive or to limit these principles to any precise form disclosed. Many modifications and variations are possible in light of the above teaching.

What is claimed is:

1. A display device, comprising:
universal serial bus (USB) hub formed within a housing of the display device;
a plurality of USB ports, each of a plurality of USB ports communicatively coupled to the USB hub via a ribbon;
a guiderail formed on an outer surface of the housing display with each of the plurality of USB ports coupled thereto to allow the movement of the USB ports along the guiderail.

2. The display device of claim 1, wherein the guiderail is formed on an outer wall of the display device orthogonal to a surface defined by a surface of a screen of the display device.

3. The display device of claim 1, wherein the guiderail comprises a rubber seal to prevent contaminants from entering the guiderail and USB ports.

4. The display device of claim 1, wherein each USB port comprises a locking mechanism to secure each USB port along the guiderail.

5. The display device of claim 1, wherein each of the plurality of USB ports are moveable upon insertion of a peripheral device into the USB port.

6. The display device of claim 1, wherein the plurality of USB ports each may be one of a type A USB port; type B USB port; mini A USB port; mini B USB port; mini AB USB port; micro A USB port; micro B USB port; micro AB USB port; and type C USB port.

7. The display device of claim 1, wherein the plurality of USB ports includes a low power switch to detect the presence of a peripheral device prior to initiating communication between the USB hub and the peripheral device.

8. A computing device, comprising:
a processor; and
a display device, the display device comprising:
data and power supply hub formed within a housing of the display device;
a plurality of data and power supply ports, each of a plurality of data and power supply ports communicatively coupled to the data and power supply hub via a ribbon;
a guiderail formed on an outer surface of the housing display with each of the plurality of plurality of data and power supply ports coupled thereto to allow the movement of the plurality of data and power supply ports along the guiderail.

9. The computing device of claim 8, wherein the guiderail is formed on an outer wall of the display device orthogonal to a surface defined by a surface of a screen of the display device.

10. The computing device of claim 8, wherein the guiderail comprises a rubber seal to prevent contaminants from entering the guiderail and plurality of data and power supply ports.

11. The computing device of claim 8, wherein each plurality of data and power supply port comprises a locking mechanism to secure each plurality of data and power supply ports along the guiderail.

12. The computing device of claim 8, wherein each of the plurality of data and power supply ports are moveable upon insertion of a peripheral device into the data and power supply port and wherein the processor initiates communication with the peripheral device via the data and power supply hub upon insertion of the peripheral device into the data and power supply port.

13. The computing device of claim 8, wherein the plurality of data and power supply ports includes a low power switch to detect the presence of a peripheral device prior to initiating communication between the data and power supply hub and the peripheral device.

14. A universal serial bus (USB) system, comprising:
a USB port communicatively coupled to a USB hub via a ribbon; and
a guiderail formed on an outer surface of a housing of a display device wherein the USB port is coupled to the guiderail to allow the movement of the USB port along the guiderail.

15. The USB system of claim 14, comprising a rubber seal to prevent contaminants from entering the guiderail and USB port.
